(19) United States
(12) Patent Application Publication
(10) Pub. No.: US 2007/0127147 A1
(43) Pub. Date: Jun. 7, 2007

(54) Contact detecting apparatus, and method for detecting contact

(75) Inventors: Toru Yokohata, Kawasaki (JP); Takeshi Iwase, Kawasaki (JP); Takahisa Ueno, Kawasaki (JP); Seigo Igaki, Kawasaki (JP); Takahiro Imamura, Kawasaki (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FUJITSU LIMITED, Kawasaki (JP)

(21) Appl. No.: 11/387,064

(22) Filed: Mar. 23, 2006

(30) Foreign Application Priority Data
Dec. 1, 2005 (JP) 2005-348356

(51) Int. Cl. G11B 27/36; G11B 21/02

(52) U.S. Cl. 360/31; 360/75

(57) ABSTRACT

In a contact detecting apparatus that detects contact of a head with a recording medium, a signal writing unit writes onto the recording medium, a signal that includes at least one predetermined frequency component; and a contact detecting unit detects the contact of the head with the recording medium based on an amplitude of the predetermined frequency component, by reading the signal written on the recording medium while changing a spacing between the head and the recording medium.

### BACKGROUND OF THE INVENTION

1. Field of the Invention

The present invention relates to a contact detecting apparatus, and a method that judges with accuracy whether a head is in or out of contact with a recording medium.

2. Description of the Related Art

In magnetic storage devices (hard disks) and testing devices related to magnetic recording (testers), there is a demand that the spacing between the head and the medium should be as small as possible to enable high-density recording.

However, when there is contact and sliding between a head and a medium, the degree of precision for determining the position of the head slider reduces, and can significantly affect the reliability of the device; for example, the dust caused by mechanical wear may cause errors in reading signals.

Therefore, it is necessary to make the spacing between a head and a medium as small as possible when the head and the medium are kept out of contact. Recently, the spacing is defined as an extremely small value; approximately thirty times the diameter of an average-sized atom. The head needs to be at such a small distance away from the medium, and thus, the contact detecting technology is gaining importance.

As an example of the contact detecting technology described above, Japanese Examined Patent Application Publication No. 7-1618 discloses a “spin down” method for measuring the absolute flying height of a head slider. It is well known that, generally speaking, when the rotation speed of a medium reduces, the flying height of the head slider reduces, and the read signal (signal strength) increases. The publication discloses a method of detecting contact between a head and a medium by monitoring the changes in the read signal with respect to the rotation speed, based on a finding that once the flying height of the head slider becomes so small that the head slider makes contact with a medium, the flying height does not reduce further; that is, the signal does not increase further.

Japanese Examined Patent Application Publication No. 7-70185 discloses a method for separating a modulation component in a read signal to identify defects on the surface of a medium. When a head slider is disturbed due to defects on the surface of a medium, a frequency modulation component due to the air bearing disturbance is superimposed on the read signal in addition to a write signal frequency component, which is a normal component in the read signal. Because the frequency of the write signal frequency component is approximately one thousand times higher than the frequency of the modulation component, it is possible to separate the modulation component using a relatively simple circuit. The publication thus discloses the method for detecting defects on the surface of a medium or the contact between a head slider and a medium.

However, the problem according to the method disclosed in the Japanese Examined Patent Application Publication No. 7-1618 is that, as the rotation speed of the medium reduces, the degree of changes in an actual read signal tends to gradually decrease and become closer and closer to zero. It is therefore extremely difficult to judge whether the head is in or out of contact with the medium.

FIG. 17 is a graph for explaining the relationship between the head slider) according to the Japanese Examined Patent Application Publication No. 7-1618. In FIG. 17, the vertical axis represents the flying height of the head slider estimated from the read signal, and the horizontal axis represents rotation speed. In terms of the strength of the read signal, the lower a plot point is positioned in the graph, the larger the read signal is. It is clear from the graph that, as the rotation speed reduces, the degree of changes in the read signal gradually decreases and becomes closer to zero.

The problem according to the method disclosed in the Japanese Examined Patent Application Publication No. 7-70185, which is to detect contact between the head and the medium by extracting the modulation component due to the air bearing disturbances from the signal is that it is extremely difficult to judge whether the head is in or out of contact with the medium when there are defects on the surface of the medium.

According to the method disclosed in this publication, once the head has made contact with a rather large defect, it is regarded that there was contact. However, there are actually some cases where the same defect is never detected again in a test performed immediately after the first contact. This kind of situation is experienced when fine dust on the medium is detected as a defect, but the dust is flicked off the medium by shock at the time of the detection and completely removed from the medium. In other words, because the sensitivity level of contact detection with defects and the like is too high, it is extremely difficult to judge whether the head is in or out of contact with the medium, from an aspect in which the influence of dust and defects is eliminated.

### SUMMARY OF THE INVENTION

It is an object of the present invention to at least solve the problems in the conventional technology.

According to an aspect of the present invention, a contact detecting apparatus that detects contact of a head with a recording medium includes a signal writing unit that writes onto the recording medium, a signal that includes at least one predetermined frequency component; and a contact detecting unit that detects the contact of the head with the recording medium based on an amplitude of the predetermined frequency component, by reading the signal written on the recording medium while changing a spacing between the head and the recording medium, and generates a detection result.

According to another aspect of the present invention, a method for detecting contact of a head with a recording medium includes writing onto the recording medium, a signal that includes at least one predetermined frequency component; and detecting the contact of the head with the recording medium based on an amplitude of the predetermined frequency component, by reading the signal written on the recording medium while changing a spacing between the head and the recording medium, and generates a detection result.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a drawing for explaining technical features of a magnetic recording apparatus according to a first embodiment of the present invention;

FIG. 2 is a functional block diagram of the magnetic recording apparatus according to the first embodiment;

FIG. 3 is a graph of a relationship between velocity of a magnetic disk and a first-order frequency component;

FIG. 4 is a drawing of an example of a head according to the first embodiment;

FIG. 5 is a drawing for explaining a Wallace relationship equation;

FIG. 6 is another drawing for explaining the Wallace relationship equation;

FIG. 7 illustrates graphs for explaining a relationship between flying height of a head and velocity of a magnetic disk according to the first embodiment;

FIG. 8 illustrates graphs for explaining amplitude of a read signal in correspondence with the spacing between a head and a magnetic disk;

FIG. 9 illustrates graphs of results of trial calculations in which an amount of change in the spacing due to the air bearing is presumed to be 20 nm (nanometers), and the actual measured values of the read signal waveforms at a time of contact vibration occurrence;

FIG. 10 is a table showing results of calculations for the amplitude of a read signal with various write frequencies and various amounts of change in the spacing;

FIG. 11 is a drawing for explaining technical features of a magnetic recording apparatus according to a second embodiment;

FIG. 12 is a functional block diagram of the magnetic recording apparatus according to the second embodiment;

FIG. 13 is a graph for explaining a relationship between velocity of a magnetic disk and complex amplitude values according to the second embodiment;

FIG. 14 illustrates graphs for explaining a relationship between flying height of a head and velocity of a magnetic disk according to the second embodiment;

FIG. 15 illustrates graphs for explaining a relationship between the amplitude level of a triple harmonic wave component and the velocity of a magnetic disk;

FIG. 16 illustrates graphs for explaining the relationship between the amplitude level of a triple harmonic wave component and the velocity of a magnetic disk; and

FIG. 17 is a graph for explaining the relationship between the rotation speed and the spacing according to the Japanese Examined Patent Application Publication No. 7-1618.

### DETAILED DESCRIPTION OF THE PREFERRED EMBODIMENTS

Exemplary embodiments of the present invention will be explained in detail below, with reference to the accompanying drawings. A magnetic recording apparatus is used as an example of the contact detecting apparatus, in the description of the embodiments.

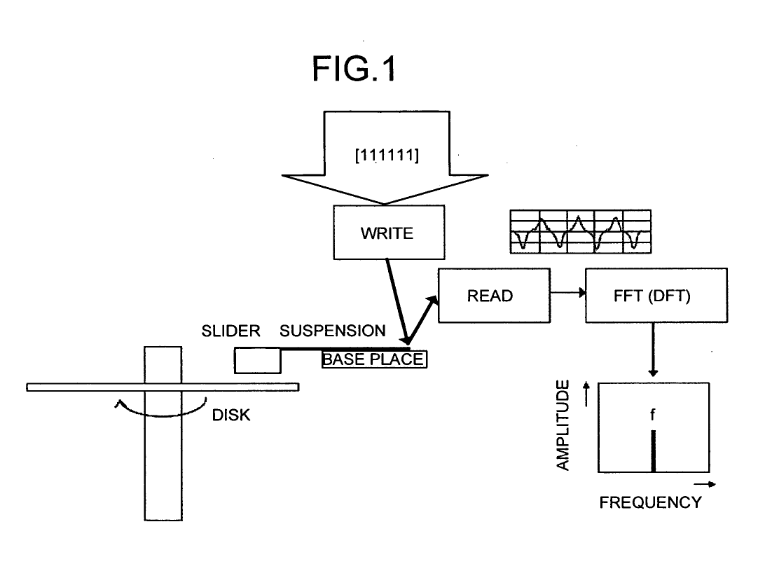

First, the technical features of a magnetic recording apparatus according to the first embodiment of the invention will be explained with reference to FIG. 1. As shown in the drawing, the magnetic recording apparatus writes, in advance, a predetermined signal pattern (for example, 111111) onto a magnetic recording medium (i.e.-a magnetic disk) at a predetermined frequency (for example, 100 MHz (megahertz)). In the following description, the signal pattern (a signal including a predetermined frequency component) written onto the magnetic disk at the predetermined frequency will be referred to as “detection target signal”.

To detect contact of the head with the magnetic disk, the magnetic recording apparatus reads the amplitude of the predetermined frequency component in the detection target signal recorded on the magnetic disk while lowering the rotation speed of the magnetic disk (or the relative velocity between the head and magnetic disk) by a predetermined proportion. When the read amplitude of the component decreases by an amount larger than a threshold value, it is determined that the head has made contact with the magnetic disk, and thus the contact of the head is detected.

As explained above, the magnetic recording apparatus reads the amplitude of the frequency component in the signal read from the magnetic disk, judges that the head has made contact with the magnetic disk when the amplitude of the component decreases by an amount larger than the threshold value, and thus detects the contact of the head with the magnetic disk. Thus, it is possible to make the accurate judgment of whether the head is in or out of contact with the magnetic disk.

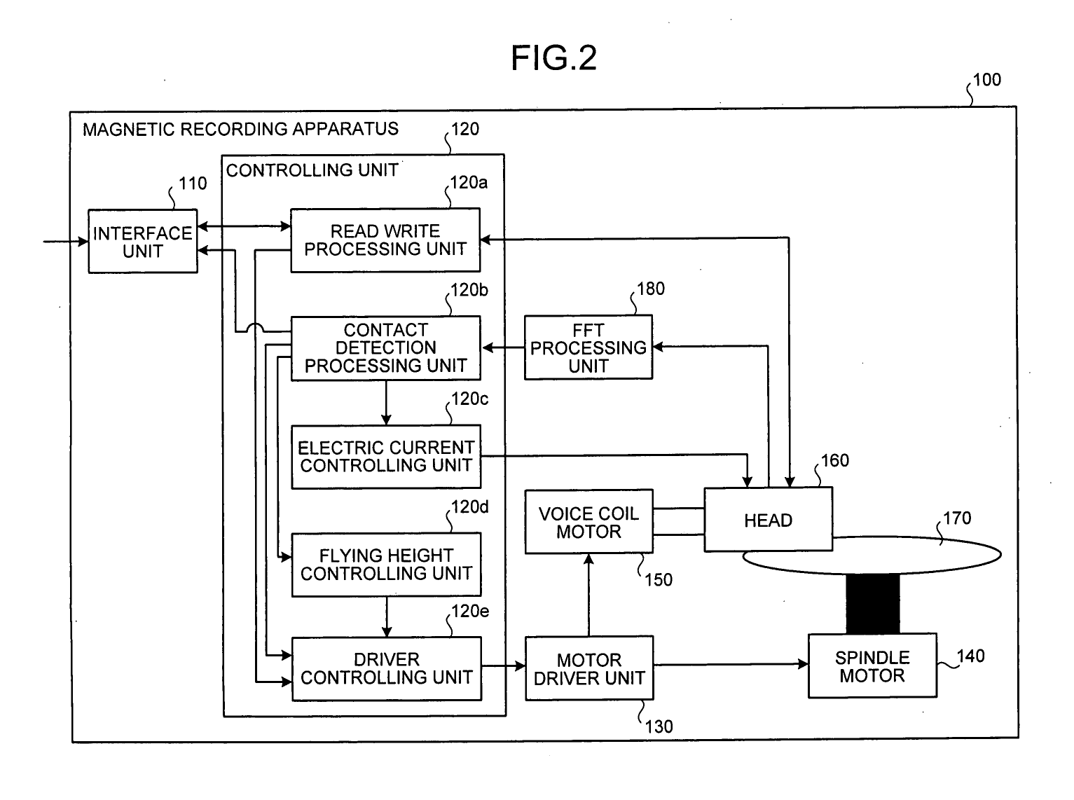

Next, the configuration of the magnetic recording apparatus according to a first embodiment will be explained with reference to FIG. 2. As shown in the drawing, a magnetic recording apparatus 100 includes an interface unit 110, a controlling unit 120, a motor driver unit 130, a spindle motor 140, a voice coil motor 150, a head 160, a magnetic disk 170, and a Fast Fourier Transform (FFT) processing unit 180.

The interface unit 110 is connected to a host computer (not shown), and performs data communication with the host computer using a predetermined communication protocol.

The motor driver unit 130 controls the spindle motor 140 and the voice coil motor 150 based on an instruction output by the controlling unit 120. The spindle motor 140 makes the magnetic disk 170 rotate at a predetermined rotation speed based on an instruction output by the motor driver unit 130. The voice coil motor 150 moves the head 160 attached to an end of an arm, according to an instruction output by the motor driver unit 130.

The magnetic disk 170 is a recording medium and is a flat disk made of resin coated with magnetic material. To record information onto the magnetic disk 170, a magnetic field from the head 160 is irradiated onto a recording area of the magnetic disk 170 into which the information is to be recorded, so that the magnetism of the magnetic material coated on the magnetic disk 170 changes. To read information from the magnetic disk 170, the head 160 is moved to a recording area of the magnetic disk 170 from which the information is to be read, so that the magnetism of the magnetic material coated on the magnetic disk 170 is read, and the information is played back.

The FFT processing unit 180 obtains a signal read by the head 160 from the magnetic disk 170, and performs a calculation based on the Fourier Transform Theory so as to calculate an average amplitude level of the frequency component in a section used in the calculation. The FFT processing unit 180 outputs the calculated average amplitude level of the frequency component to the controlling unit 120.

Because the detection target signal is written on the magnetic disk 170 in advance (the detection target signal is written in advance by a read write processing unit 120a), the FFT processing unit 180 outputs the average amplitude level of the frequency component in the detection target signal (hereinafter, “the amplitude level information”) to the controlling unit 120.

The controlling unit 120 controls the writing and the reading of data to and from the magnetic disk 170, and also detects contact of the head 160 with the magnetic disk 170. The controlling unit 120 includes the read write processing unit 120a, a contact detection processing unit 120b, an electric current controlling unit 120c, a flying height controlling unit 120d, and a driver controlling unit 120e.

The read write processing unit 120a performs the writing and the reading of data to and from the magnetic disk 170 according to a write request or a read request from the host computer. The read write processing unit 120a also writes the signal pattern (111111) onto the magnetic disk 170 at a predetermined frequency (or at various frequencies) according to an instruction from the host computer.

The contact detection processing unit 120b detects contact of the head 160 with the magnetic disk 170. More specifically, to detect contact of the head 160 with the magnetic disk 170, the contact detection processing unit 120b lowers the rotation speed of the magnetic disk 170 by a predetermined proportion and also obtains the amplitude level information from the FFT processing unit 180. When the amplitude of the predetermined frequency component (a first-order frequency component) decreases by an amount larger than a threshold value, the contact detection processing unit 120b judges that the head 160 has made contact with the magnetic disk 170, and thus detects the contact of the head 160.

To lower the rotation speed of the magnetic disk 170 by the predetermined proportion, the contact detection processing unit 120b instructs the driver controlling unit 120e to lower the rotation speed of the magnetic disk 170 by the predetermined proportion. The driver controlling unit 120e outputs an instruction to the motor driver unit 130 to control the spindle motor 140 and the voice coil motor 150. Upon receiving the instruction from the contact detection processing unit 120b to lower the rotation speed of the magnetic disk 170 by the predetermined proportion, the driver controlling unit 120e controls the spindle motor 140 so that the number of rotations of the magnetic disk 170 decreases by the predetermined proportion.

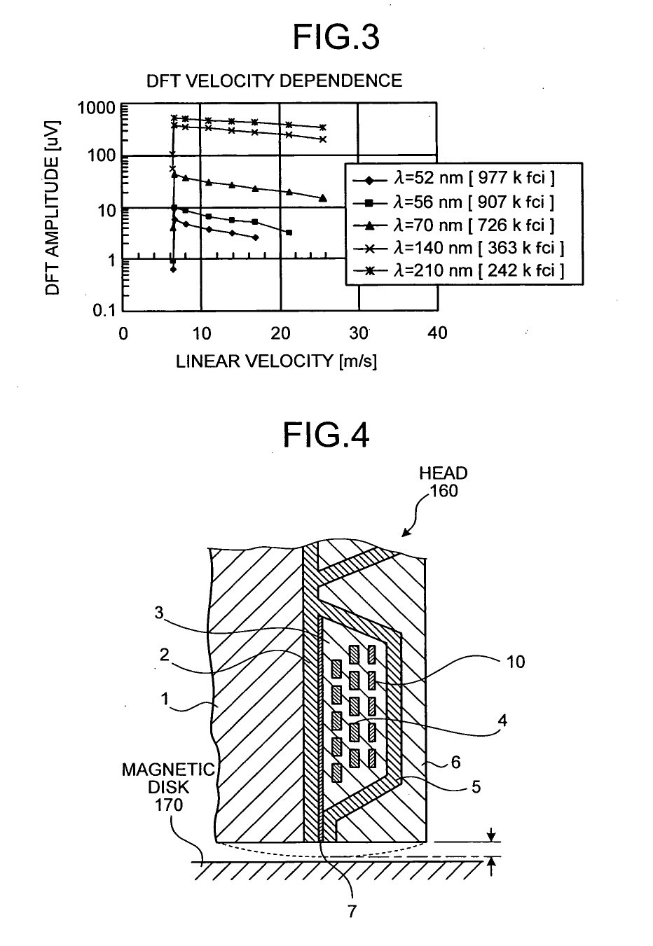

Next, the relationship between the velocity (i.e. a value obtained by converting the rotation speed to a velocity) of the magnetic disk 170 and the amplitude of the first-order frequency component (i.e. the frequency component in the detection target signal) will be explained with reference to a graph in FIG. 3. The example in FIG. 3 illustrates the relationship between the first-order frequency component and the velocity of the magnetic disk 170 observed in various detection target signals. The graph explains the relationship between the amplitude of the frequency component and the velocity of the magnetic disk for each of the different wavelengths. It is clear from FIG. 3 that, when the velocity of the magnetic disk 170 reaches a certain level (approximately 6 m/s in the example in FIG. 3), each of the amplitudes of the first-order frequency components drastically decreases. This type of drastic decrease is observed regardless of the length of the data sequence used in the calculation in a process of the Fourier calculation processing. Also, as a result of an experiment in which a laser vibrometer (not shown) was used together, it was confirmed that the head 160 vibrated before and after the point in time when each of the amplitudes of the first-order frequency components drastically decreased.

More specifically, before each drastic decrease of the amplitudes of the first-order frequency components, head vibration did not occur; however, the moment when each of the amplitudes of the first-order frequency components drastically decreased, a head vibration occurred and this vibration lasted for a period of time. This vibration was caused by the contact of the head 160 with the magnetic disk 170.

When the rotation speed of the magnetic disk 170 increases while the head 160 is still vibrating, the amplitude of the first-order frequency component goes back to the value before the drastic decrease, and the vibration of the head 160 stops.

Returning to the description of the operation of the contact detection processing unit 120b, after detecting the contact of the head 160 with the magnetic disk 170, the contact detection processing unit 120b notifies the electric current controlling unit 120c notifying that the head 160 has made contact with the magnetic disk 170.

Alternatively, after detecting the contact of the head 160 with the magnetic disk 170, the contact detection processing unit 120b may cause a speaker (not shown) to make a warning sound to notify a manager of the magnetic recording apparatus 100 that the head 160 has made contact, or may cause the host computer to display that the head 160 has made contact.

Using electric current, the electric current controlling unit 120c adjusts the spacing between the head 160 and the magnetic disk 170 by causing a magnetic pole tip of the head 160 to generate heat and expand. Upon receiving notification from the contact detection processing unit 120b that the head 160 has made contact, the electric current controlling unit 120c stops the electric current supply to the magnetic pole tip of the head 160 to cause the magnetic pole tip of the head 160 to contract. By this operation of the electric current controlling unit 120c to cause the magnetic pole tip of the head 160 to contract, it is possible to efficiently reduce the head vibration due to the contact of the head 160.

FIG. 4 is a drawing of an example of the head 160 according to the first embodiment. As shown in the drawing, the head 160 includes a substrate 1 and a lower magnetic pole 2, a thin film coil 4 formed with an intervening electrically insulative layer 3, an upper magnetic pole 5, and a protective layer 6 that are sequentially formed on the substrate 1. When a thin film resistor 10 inside the electrically insulative layer 3 is caused to generate heat by electric current, due to the differences in the thermal expansion ratios between the two magnetic pole tips 2 and 5 and the electrically insulative layer 3, and between the substrate 1 and the protective layer 6, a magnetic pole tip 7 projects outward as shown with a dotted line in FIG. 4. In other words, by having the electric current controlling unit 120c control the electric current flowing in the thin film resistor 10, it is possible to control the amount of projection of the magnetic pole tip 7.

Returning to the description of the operation of the contact detection processing unit 120b, the contact detection processing unit 120b calculates a flying height of the head 160 based on, for example, the amplitude level information received from the FFT processing unit 180.

The flying height of the head 160 can be calculated using the Wallace relationship equation shown below:

$${( d + a )}_{x} - {( d + a )}_{ref} = \frac{λ}{2 π} ln ( \frac{{V}_{ref}}{{V}_{x}} ) \qquad ( 1 )$$

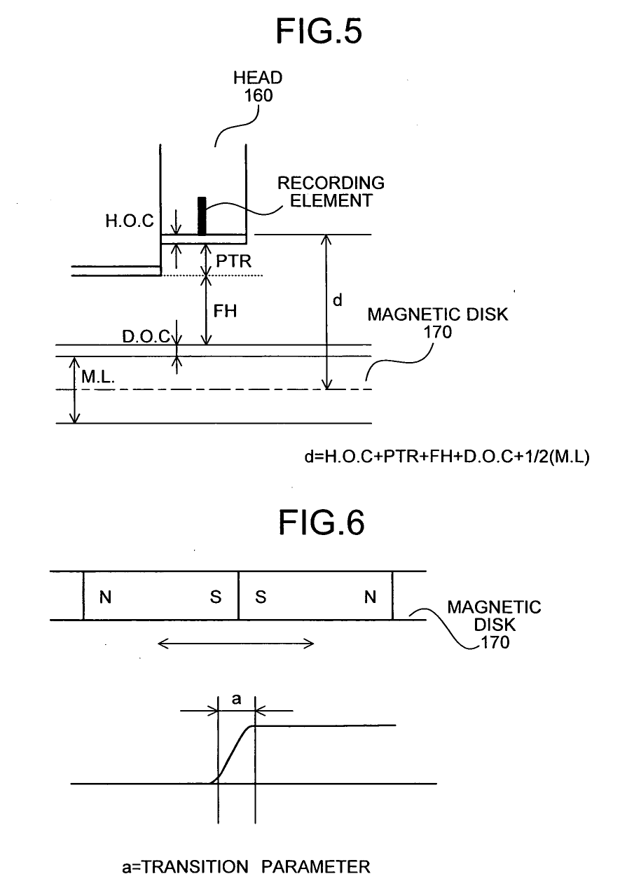

Next, the symbols “a” and “d” used in Equation (1) will be explained. FIG. 5 and FIG. 6 are drawings for explaining the Wallace relationship equation.

As shown in FIG. 5, the symbol “d” used in Equation (1) denotes a sum of the Head Over Coat (H. O. C.), the Pole Tip Recession (P. T. R.), the Flying Height (F. H.), the Disk Over Coat (D. O. C.), and a half of the Magnetic Layer (M. L.). As shown in FIG. 6, the symbol “a” used in Equation (1) denotes a transition parameter, which is the width of a transition area in which the signal strength on the magnetic disk varies.

A reference value (for example, a value at a point in time when the head 160 makes contact with the magnetic disk 170) is assigned to a character having a subscript “ref” (reference). The contact detection processing unit 120b obtains reference values in advance, and uses the reference values for the calculation of the flying height. A reference value of the amplitude level is assigned to V_{ref} used in Equation (1). A value of the amplitude level at the velocity for which the flying height is to be calculated is assigned to Vₓ.

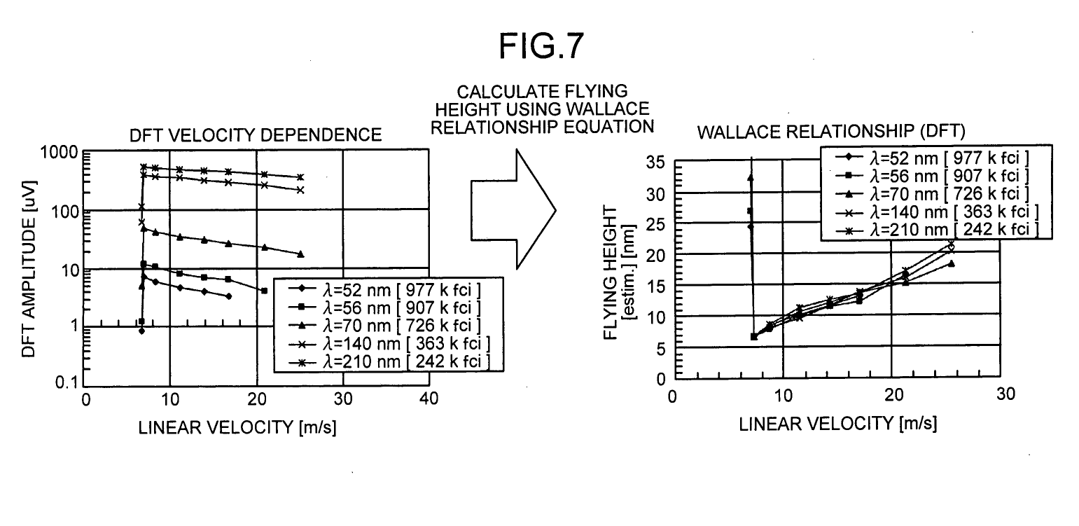

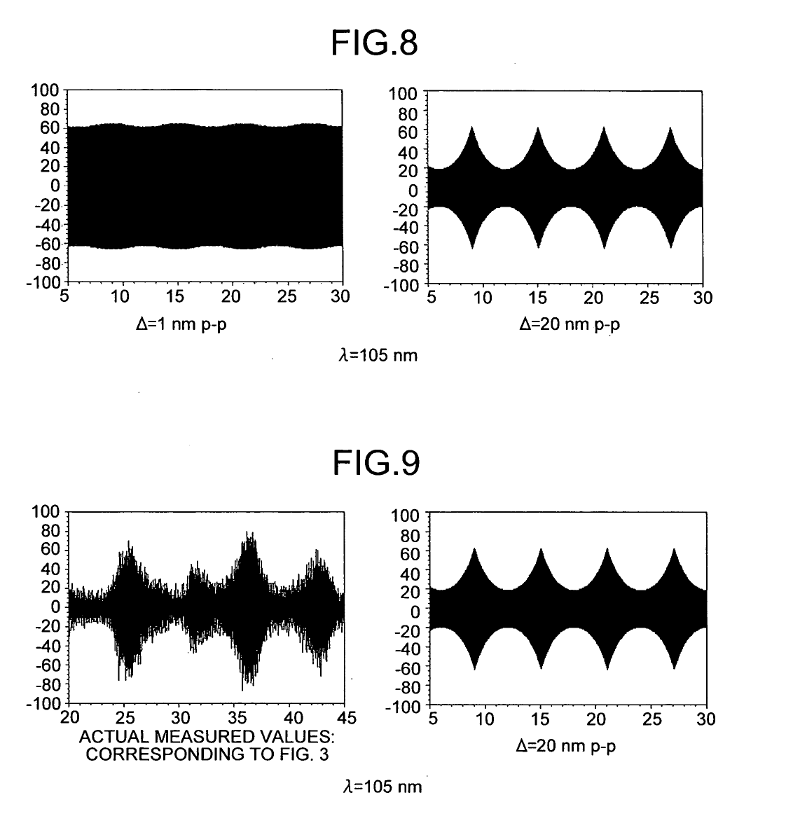

FIG. 7 illustrates graphs for explaining the relationship between the flying height of the head 160 and the velocity of the magnetic disk 170. The graph on the left side in FIG. 7 is for explaining the relationship between the amplitude of the first-order frequency component and the velocity of the magnetic disk 170, as explained using FIG. 3. By applying the Wallace relationship equation to the relationship shown in the graph on the left, the relationship between the flying height of the head 160 and the velocity of the magnetic disk 170 can be calculated, as shown in the graph on the right side in FIG. 7. As shown in the graph on the right, when the velocity of the magnetic disk 170 has reached a certain level, the flying height of the head 160 increases by a large amount. It is understood that the head 160 made contact with the magnetic disk 170 at this point in time.

The contact detection processing unit 120b provides the flying height controlling unit 120d with information regarding the relationship between the flying height of the head 160 and the velocity of the magnetic disk 170 (hereinafter “the flying height control information”), the relationship being calculated using the Wallace relationship equation.

The flying height controlling unit 120d receives the flying height control information from the contact detection processing unit 120b and controls the driver controlling unit 120e so that the head 160 does not make contact with the magnetic disk 170. More specifically, as shown in the example in FIG. 7, when the velocity of the magnetic disk 170 is equal to or lower than a predetermined level (approximately 6 m/s in the example in FIG. 7), the head 160 makes contact with the magnetic disk 170. Thus, the flying height controlling unit 120d controls the driver controlling unit 120e so that the velocity of the magnetic disk 170 does not become equal to or lower than the predetermined level.

Because it is preferable to make the spacing between the head 160 and the magnetic disk 170 as small as possible, the flying height controlling unit 120d controls the driver controlling unit 120e so that the spacing between the head 160 and the magnetic disk 170 is kept the same as the spacing at a time immediately before the head 160 makes contact with the magnetic disk 170 (hereinafter, “the optimal spacing”); in other words, so that the flying height of the head 160 is equal to the optimal spacing (or a value obtained by multiplying the optimal spacing by a predetermined value).

Further, the amplitude of a read signal that corresponds to the spacing between the head 160 and the magnetic disk 170 can be calculated using the Wallace relationship equation. FIG. 8 illustrates graphs for explaining the amplitude of a read signal that corresponds to the spacing between the head 160 and the magnetic disk 170. The example shown in FIG. 8 presents results of trial calculations of the amplitude of a read signal on a presumption that a write signal is at approximately 100 MHz (λ=105 nm), the air bearing modulation frequency is approximately 170 kHz (kilohertz), and the amount of change in the spacing (i.e. the spacing between the head 160 and the magnetic disk 170) due to the air bearing is one of two possibilities, namely 1 nm (when there is no occurrence of contact vibration of the head 160) and 20 nm (when there is occurrence of contact vibration of the head 160).

FIG. 9 illustrates graphs of the results of the trial calculations in which the amount of change in the spacing due to the air bearing is presumed to be 20 nm, and the actual measured values of the read signal waveforms at the time of contact vibration occurrence. In FIG. 9, the waveforms on the left are the actual measured values of the read signal waveforms, whereas the waveforms on the right are the results of the trial calculations of the read signal waveforms. As we compare the waveforms on the left with the ones on the right, it is observed that these waveforms are very similar to each other. Thus, it is concluded that the read signal level at the time of the vibration continuation, shown in FIG. 3, has decreased due to the contact between the head 160 and the magnetic disk 170.

More specifically, according to the results shown in FIG. 3, vibration occurs because of the contact between the head 160 and the magnetic disk 170 when the velocity becomes lower than a certain level. Because of this vibration, it looks as if the amplitude of the first-order frequency component decreased drastically due to the appearance after averaging the values during the period. (In the example shown in FIG. 7, it looks as if the spacing between the head 160 and the magnetic disk 170 increased). Note that the vibration amplitude at this time is approximately tens of nanometers p-p (peak to peak) to 0.1 μm p-p.

The reason why there is vibration as soon as the head 160 makes contact with the magnetic disk 170 is that the degree of unevenness of the magnetic disk 170 is rather small, and that the magnetic disk 170 is a smooth-surfaced medium having an average unevenness smaller than the thickness of the lubricant film formed on the surface of the magnetic disk 170. The average unevenness of the magnetic disk 170 is within the range of approximately 0.3 nm to 0.5 nm. The thickness of the lubricant film formed on the surface of the medium through a lubrication processing is within the range of approximately 0.8 nm to 2.8 nm.

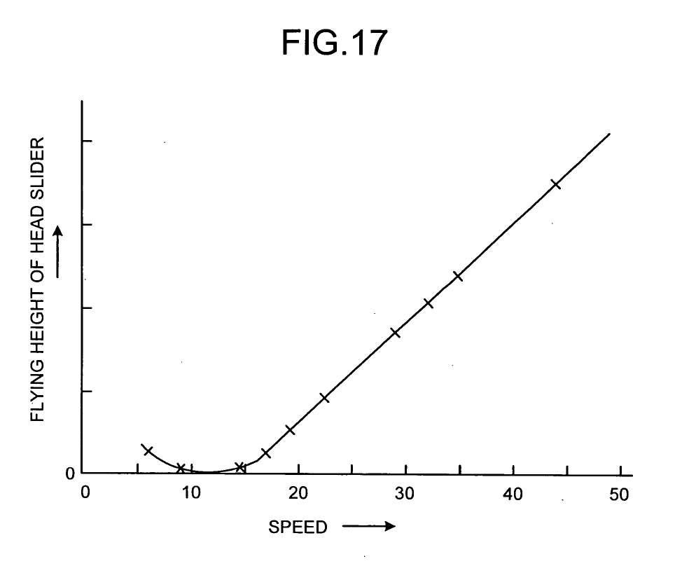

The relationship between the read signal and the velocity of the disk (shown in FIG. 17) discussed in the Japanese Examined Patent Application Publication No. 7-1618 is observed only when the average unevenness of a magnetic disk is extremely larger than that of the magnetic disk 170 according to the first embodiment. In recent years, the average unevenness of most of magnetic disks being used is at the same level as the unevenness of the magnetic disk according to the first embodiment. Thus, the head contact detection method according to the first embodiment is more effective than the method disclosed in the Japanese Examined Patent Application Publication No. 7-1618.

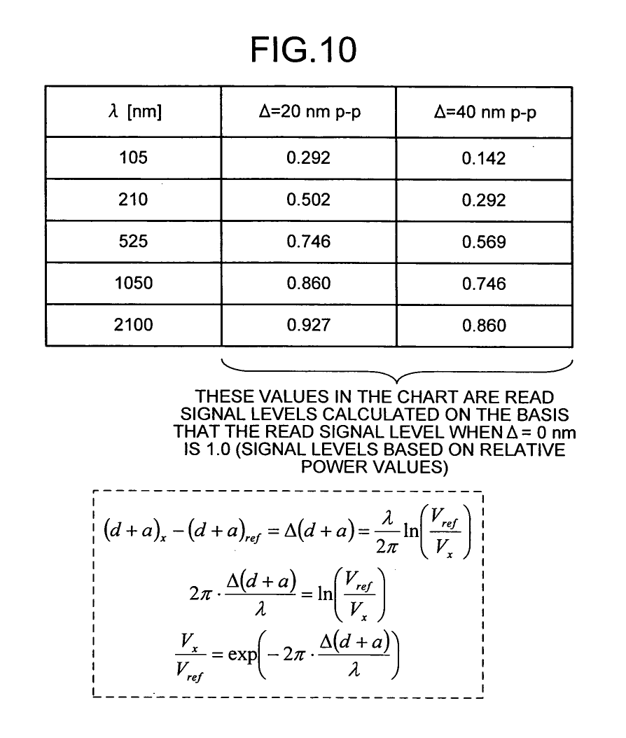

Calculations that are the same as the ones shown in FIG. 8 were performed using various write frequencies and various amounts of changes in the spacing (20 nm p-p and 40 nm p-p). FIG. 10 is a table for showing the results of the calculations for the amplitude of the read signal with the various write frequencies and the various amounts of changes in the spacing. In FIG. 10, the write frequencies are converted to write signals of wavelengths λ (on the medium).

As shown in FIG. 10, the read signal level at the time of the vibration continuation is determined substantially according to the value of the amount of the change/λ. In other words, it is possible to conclude the amplitude value of vibration by monitoring the read signal level after occurrence of the vibration.

Further, the amplitude of a read signal can be expressed using a simple exponential function based on the Wallace relationship equation, as shown by the equations in FIG. 10. It is possible to estimate the amplitude of vibration using the write wavelength λ that is known from the conditions used in the experiment and V_{ref} and Vₓ that are clearly indicated in the actual measured values. The amplitude of vibration may be estimated by, for example, the contact detection processing unit 120b shown in FIG. 2. In such a situation, the contact detection processing unit 120b outputs the calculated amplitude of vibration to the host computer to provide the manager with the amplitude of vibration.

As explained so far, in the magnetic recording apparatus 100 according to the first embodiment, the read write processing unit 120a writes onto the magnetic disk 170, in advance, a signal that includes the predetermined frequency component, the contact detection processing unit 120b controls the driver controlling unit 120e so that the rotation speed of the magnetic disk 170 is lowered by a predetermined portion, to thereby read the detection target signal. When the amplitude of the predetermined frequency component (the first-order frequency component) in the signal read from the magnetic disk 170 decreases by an amount larger than the threshold value, it is judged that the head 160 has made contact with the magnetic disk 170, and thus the contact of the head 160 is detected. Accordingly, it is possible to detect the contact of the head 160 with the magnetic disk 170 accurately, while avoiding technical ambiguity of the conventional technique.

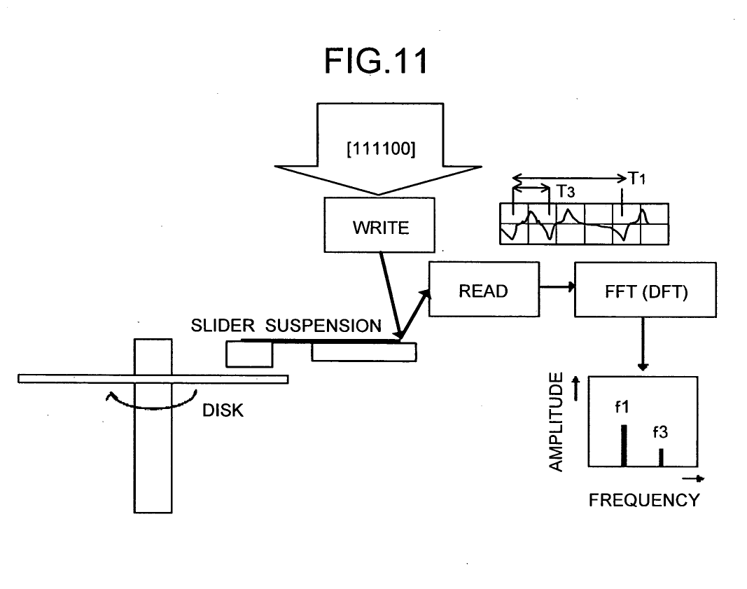

Next, technical features of a magnetic recording apparatus according to a second embodiment of the present invention will be explained with reference to FIG. 11. As shown in the drawing, the magnetic recording apparatus writes onto a magnetic disk, in advance, a signal pattern (e.g. 111100) that includes two waves, namely a first-order component and a triple harmonic wave component, at a predetermined frequency. In the following description, a signal that includes a plurality of frequency components will be referred to as a complex signal.

To detect contact of a head with a magnetic disk, the magnetic recording apparatus reads the amplitudes of predetermined frequency components (for example, the first-order component and the triple harmonic wave component) in the complex signal recorded on the magnetic disk while lowering the rotation speed of the magnetic disk by a predetermined proportion. Contact of the head is detected based on the amplitudes of the two types of frequency components that have been read. Defects in the magnetic disk are also detected based on the magnitudes of the amplitudes of these frequency components.

The magnetic recording apparatus according to the second embodiment detects contact of the head based on changes in the amplitudes of the frequency components. Thus, it is possible to make accurate judgment of whether the head is in or out of contact with a medium. Further, it is possible to accurately detect defects in a magnetic disk, based on the amplitude of one of the first-order component and the triple harmonic wave component in the complex signal.

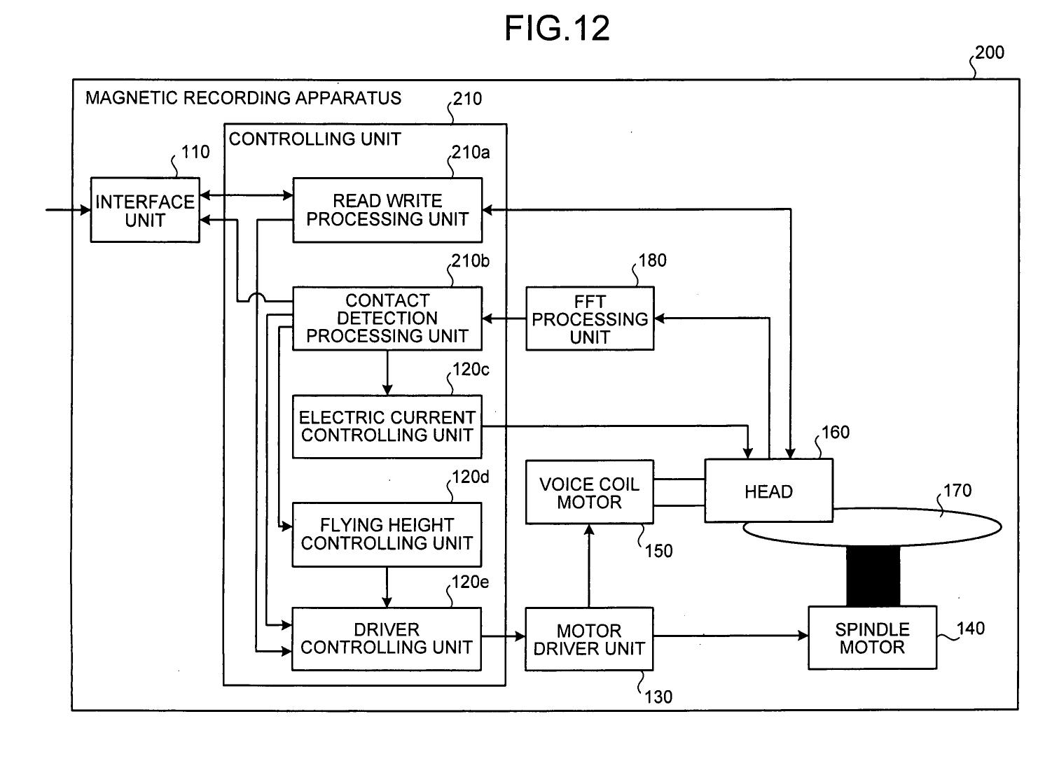

Next, a configuration of the magnetic recording apparatus according to the second embodiment will be explained with reference to FIG. 12. As shown in the drawing, a magnetic recording apparatus 200 includes a controlling unit 210. Other configurations and constituent elements of the magnetic recording apparatus 200 are same as those of the magnetic recording apparatus 100 shown in FIG. 2. The same reference numerals are used for identical constituent elements, and explanation thereof will be omitted.

The controlling unit 210 controls the writing and the reading of data to and from the magnetic disk 170 and also detects contact of the head 160 with the magnetic disk 170 and defects in the magnetic disk 170. The controlling unit 210 includes a read write processing unit 210a and a contact detection processing unit 210b. Other configurations of the controlling unit 210 are the same as those of the controlling unit 120 shown in FIG. 2. The same reference numerals are used for referring to identical constituent elements, and explanation thereof will be omitted.

The read write processing unit 210a performs the writing and the reading of data to and from the magnetic disk 170 based on a write request or a read request from a host computer. The read write processing unit 210a also writes the signal pattern (111100) onto the magnetic disk 170 at a predetermined frequency (or at various frequencies) based on an instruction from the host computer.

The contact detection processing unit 210b detects contact of the head 160 with the magnetic disk 170 and defects in the magnetic disk 170. The operation performed by the contact detection processing unit 210b to detect contact of the head 160 with the magnetic disk 170 will be explained first.

To detect contact of the head 160 with the magnetic disk 170, the contact detection processing unit 210b lowers the rotation speed of the magnetic disk 170 by a predetermined proportion and also obtains the amplitude level information of the first-order component and the triple harmonic wave component from the FFT processing unit 180. When a value calculated from the relationship between the amplitude levels of the frequency components (hereinafter, “the complex amplitude value”) decreases by an amount larger than a threshold value, the contact detection processing unit 210b judges that the head 160 has made contact with the magnetic disk 170 and thus detects the contact of the head 160.

The complex amplitude value A is calculated using Equation (2) shown below:

$$A = \frac{3 λ}{4 π} ln \frac{{V}_{1}}{{V}_{3}} \qquad ( 2 )$$

In this equation, the symbol V₁ denotes the amplitude level of the first-order frequency component. The symbol V₃ denotes the amplitude level of the triple harmonic wave component.

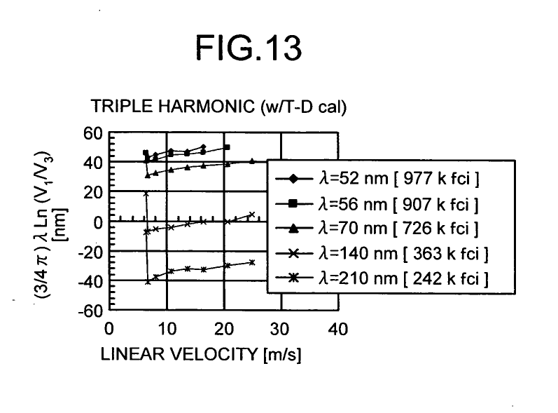

FIG. 13 is a graph for explaining the relationship between the velocity of the magnetic disk 170 and the complex amplitude value. It can be observed from the drawing that, when the velocity of the magnetic disk 170 reaches a certain level (approximately 6 m/s (meters per second) in the example in FIG. 13), the complex amplitude value drastically increases.

Also, as a result of an additional experiment in which a laser vibrometer (not shown) was used together, it was observed that the head 160 vibrated before and after the drastic increase. More specifically, before each drastic increase of the complex amplitude values, head vibration did not occur; however, the moment when each of the complex amplitude values drastically increased, head vibration occurred and this vibration lasted for a period of time. This vibration was caused by the contact of the head 160 with the magnetic disk 170. When the rotation speed of the magnetic disk 170 increases while the head 160 is still vibrating, the vibration of the head 160 stops.

Returning to the description of the operation of the contact detection processing unit 210b, upon receiving the amplitude level of the first-order component and the triple harmonic wave component from the FFT processing unit 180, the contact detection processing unit 210b calculates the flying height of the head 160 based on the received amplitude level, using the Equation (3) shown below:

$$( d + a ) = \frac{3 λ}{4 π} ln ( \frac{{V}_{1}}{{V}_{3}} ) + const . ( λ , g ) \qquad ( 3 )$$

The symbols “d” and “a” used in Equation (3) are the same as the symbols “d” and “a” used in Equation (1). Explanation thereof will be therefore omitted. In Equation (3), the symbol V₁ denotes the amplitude level of the first-order frequency component. The symbol V₃ denotes the amplitude level of the triple harmonic wave component.

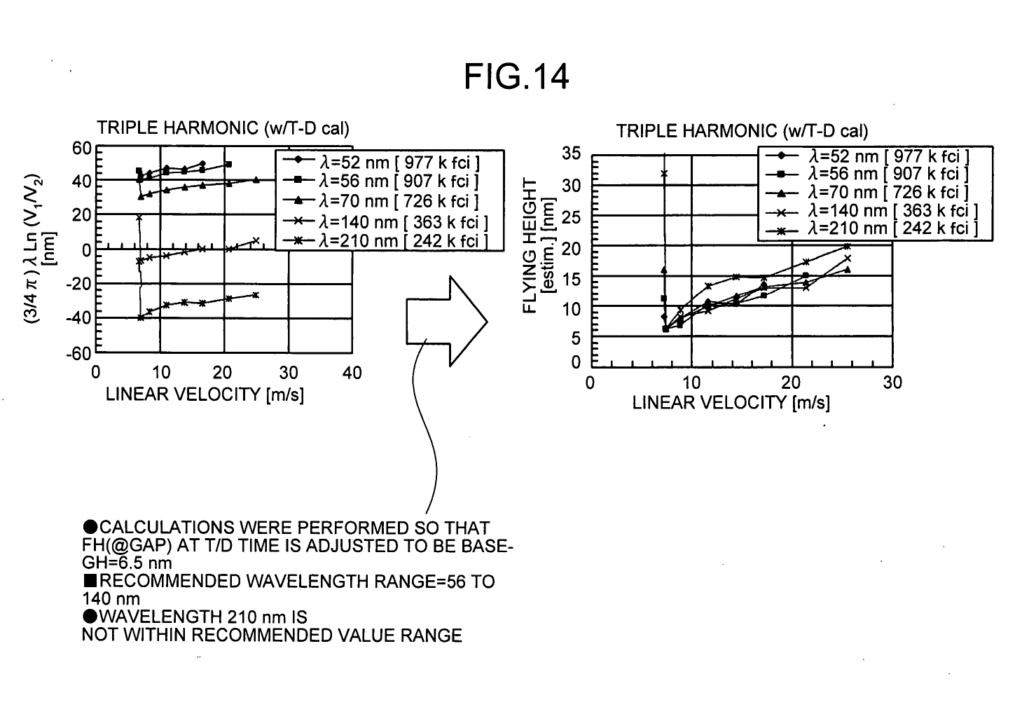

FIG. 14 illustrates graphs for explaining the relationship between the flying height of the head 160 and the velocity of the magnetic disk 170. The graph on the left side in FIG. 14 is for explaining the relationship between the complex amplitude value and the velocity of the magnetic disk 170, as explained using FIG. 13. By applying Equation (3), the relationship between the flying height of the head 160 and the velocity of the magnetic disk 170 can be calculated, as shown in the graphs on the right side in FIG. 14.

Because Equation (3) includes unspecified constants, namely “Const. (λ, g)”, calculations were performed to adjust the value of the minimum flying height of the head 160 (i.e. the flying height at the time when the head 160 makes contact with the magnetic disk 170 in the example shown in FIG. 14) to be 6.5 nm. As shown in the drawing, when the velocity of the magnetic disk 170 has reached a predetermined level, the flying height of the head 160 increases by a large amount. It is understood that the head 160 made contact with the magnetic disk 170 at this point in time.

The contact detection processing unit 210b sends to the flying height controlling unit 120d, the relationship between the flying height of the head 160 and the velocity of the magnetic disk 170, the relationship being calculated using Equation (3). Also, when the head 160 has made contact with the magnetic disk 170, the contact detection processing unit 210b notifies the electric current controlling unit 120c that the head 160 has made contact with the magnetic disk 170.

Next, the operation performed by the contact detection processing unit 210b to detect defects in the magnetic disk 170 will be explained. To detect defects in the magnetic disk 170, the contact detection processing unit 210b monitors the amplitude level of the triple harmonic wave component. When the value of the amplitude level of the triple harmonic wave component becomes lower than a predetermined value, the contact detection processing unit 210b judges that the head 160 has made contact with a defect in the magnetic disk 170. The predetermined value is one of a noise level of the magnetic disk 170, a noise level of the magnetic recording apparatus 200, and a value obtained by multiplying one of these noise levels by a predetermined value (for example, a value within the range of 1.0 to 1.3).

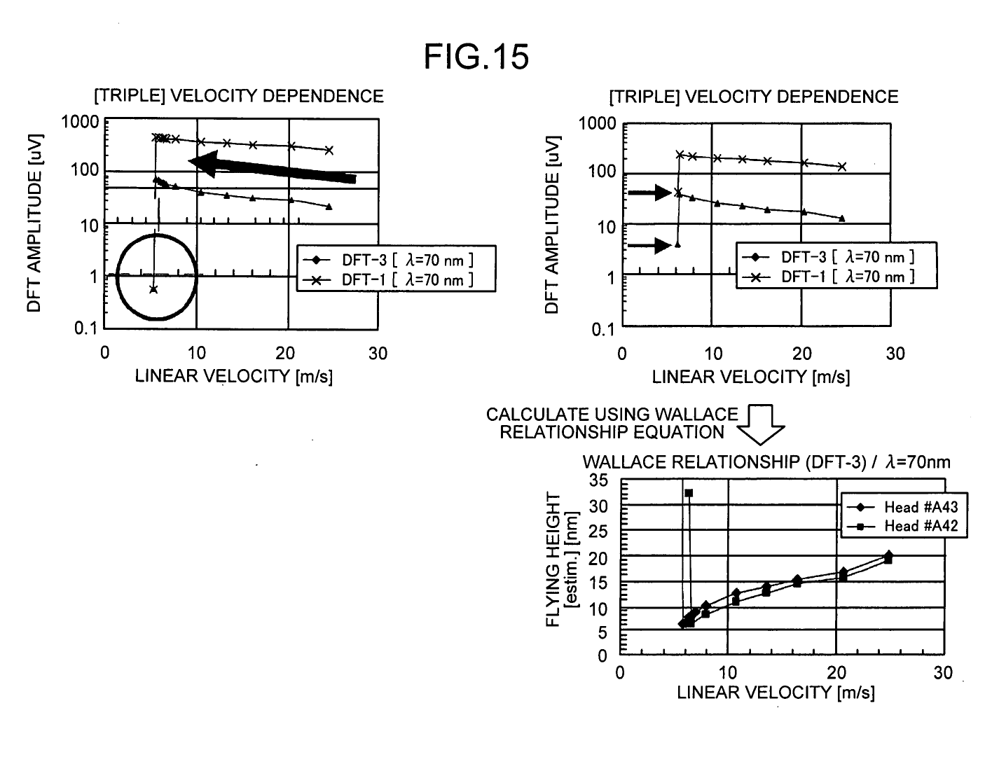

FIG. 15 illustrates graphs for explaining the relationship between the amplitude level of the triple harmonic wave component and the velocity of the magnetic disk 170. As shown in the graph on the left side in FIG. 15, when the head 160 has made contact with a defect in the magnetic disk 170, each of the values of the amplitude levels is substantially at the same level as the noise level of the magnetic recording apparatus 200. On the other hand, when the head 160 has made contact with the magnetic disk 170, each of the values of the amplitude levels of the frequency components is more than 10 times larger than the noise level, as shown in the graph on the right side in FIG. 15.

Generally speaking, when the magnetic disk 170 has a defect (e.g. a flaw or dust), the height of such a flaw (for example, a flaw that is large enough to be visible and caused by contact of the head 160 with the magnetic disk 170) may be 0.2 μm (micrometer) to a few micrometers. When the head 160 has moved to a position with such a flaw, the spacing between the head 160 and the magnetic disk 170 becomes larger than the vibration due to the contact of the head 160 with the magnetic disk 170, and thus the amplitude level of the triple harmonic wave component (or the first-order frequency component) decreases by a large amount.

After detecting a defect in the magnetic disk 170, the contact detection processing unit 210b may cause a speaker (not shown) to output a warning sound to notify a manager of the magnetic recording apparatus 200 that the head 160 has made contact with the defect, or may cause the host computer to display that the head 160 has made contact with the defect.

Moreover, the contact detection processing unit 210b can detect contact of the head 160 in the same way as the contact detection processing unit 120b does according to the first embodiment, by focusing on only one frequency component out of the first-order component and the triple harmonic wave component in a complex signal.

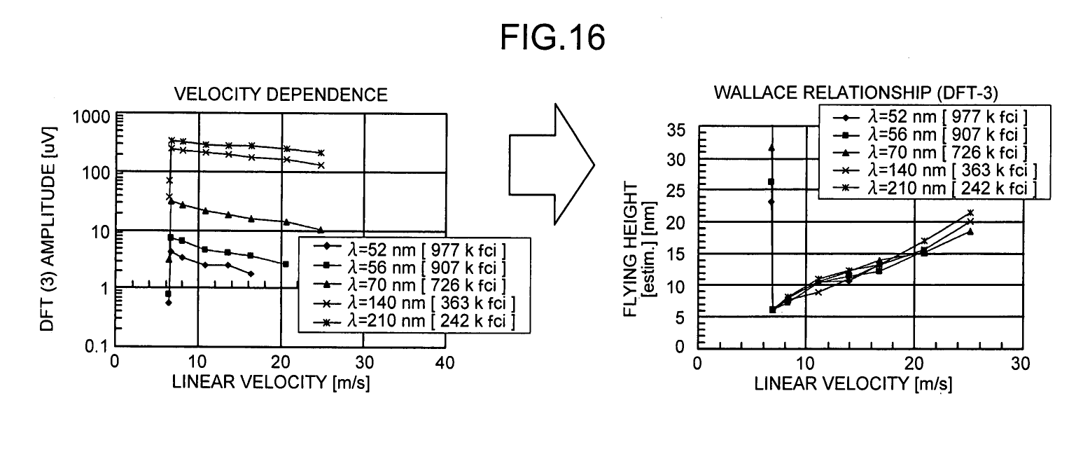

FIG. 16 illustrates graphs for explaining the relationship between the amplitude level of the triple harmonic wave component and the velocity of the magnetic disk 170. As shown in FIG. 16, it is possible to obtain results that are equivalent to the results shown in FIG. 7 by focusing only on the amplitude level of the triple harmonic wave component.

As explained so far, in the magnetic recording apparatus 200 according to the second embodiment, the read write processing unit 210a writes onto the magnetic disk 170, in advance, the complex signal that includes the plurality of frequency components, the contact detection processing unit 210b controls the driver controlling unit 120e so that the rotation speed of the magnetic disk 170 is lowered by a predetermined portion, to thereby read the complex signal. When the complex amplitude value of the frequency components (the first-order frequency component and the triple harmonic wave component) in the signal read from the magnetic disk 170 decreases by an amount larger than the threshold value, it is judged that the head 160 has made contact with the magnetic disk 170, and thus the contact of the head 160 is detected. Accordingly, it is possible to accurately detect the contact of the head 160 with the magnetic disk 170.

Also, by focusing on the amplitude of the triple harmonic wave component, the contact detection processing unit 210b judges that the head 160 has made contact with a defect in the magnetic disk 170 when the amplitude becomes lower than a predetermined value, and thus detects the defect in the magnetic disk 170. Accordingly, it is possible to accurately detect a defect (a flaw or dust) in the magnetic disk 170 while properly distinguishing contact of the head 160 with the magnetic disk 170 from contact of the head 160 with a defect in the magnetic disk 170.

According to the second embodiment, the contact detection processing unit 210b detects contact of the head 160 and defects by focusing on the amplitude levels of the first-order component and the triple harmonic wave component in the complex signal; however, the present invention is not limited to this example. It is possible to obtain the similar results by using any signal pattern that includes two waves having mutually different wavelengths and the amplitudes of these components.

Thus, according to one aspect of the present invention, it is possible to make accurate judgment of whether the head is in or out of contact with the magnetic disk.

Moreover, defects on the head can be detected precisely.

Furthermore, it is possible to quickly stop vibrations caused when the head makes contact with the recording medium.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A contact detecting apparatus that detects contact of a head with a recording medium, the contact detecting apparatus comprising:
a signal writing unit that writes onto the recording medium a signal that includes at least one predetermined frequency component; and
a contact detecting unit that detects contact of the head with the recording medium based on an amplitude of the predetermined frequency component, by reading the signal written on the recording medium while changing a spacing between the head and the recording medium, and generates a detection result.

2. The contact detecting apparatus according to claim 1, wherein
the contact detecting unit reads the signal while decreasing the spacing between the head and the recording medium, and
if a decrease in the amplitude of the predetermined frequency component is larger than a threshold value, the contact detecting unit judges that the head has made contact with the recording medium.

3. The contact detecting apparatus according to claim 1, wherein
the contact detecting unit changes the spacing between the head and the recording medium by changing a rotation speed of the recording medium.

4. The contact detecting apparatus according to claim 1, wherein
the signal includes a plurality of frequency components including the predetermined frequency component.

5. The contact detecting apparatus according to claim 1, wherein
if the amplitude of the predetermined frequency component in the signal becomes lower than a predetermined level, the contact detecting unit judges that the head has made contact with a defect on the recording medium.

6. The contact detecting apparatus according to claim 5, wherein
the predetermined level is calculated based on a noise level of the recording medium and a noise level of the contact detecting apparatus.

7. The contact detecting apparatus according to claim 1, wherein when detecting the spacing between the head and the recording medium, a spacing between the head and the recording medium immediately before the contact detecting unit detects the contact of the head with the recording medium is set as a limit spacing, and the limit spacing is proofread based on a standard limit spacing measured in some other unit.

8. The contact detecting apparatus according to claim 1, further comprising:
a flying height controlling unit that controls a flying height of the head based on the detection result.

9. The contact detecting apparatus according to claim 8, wherein
the flying height controlling unit controls the flying height of the head based on an optimum spacing, which is spacing between the head and the recording medium at a time immediately before the contact detecting unit detects that there was contact.

10. The contact detecting apparatus according to claim 9, wherein
the flying height controlling unit controls the flying height of the head so that the flying height is equal to a value obtained by multiplying the optimum spacing by a predetermined value.

11. The contact detecting apparatus according to claim 1, further comprising:
an electric current controlling unit that adjusts the spacing between the head and the recording medium by heating a magnetic pole tip of the head, and causing the magnetic pole tip to expand.

12. The contact detecting apparatus according to claim 11, wherein
when the contact detecting unit detects the contact of the head with the recording medium, the electric current controlling unit discontinues the heating of the magnetic pole tip.

13. The contact detecting apparatus according to claim 1, wherein
when the contact detecting unit judges that the head has made contact with a defect on the recording medium, the contact detecting unit outputs a notification that the head has made contact with the defect.

14. The contact detecting apparatus according to claim 1, further comprising:
a contact vibration calculating unit that calculates an amplitude of vibration occurring when the head makes contact with the recording medium, based on a wavelength of the signal recorded on the recording medium, and outputs a calculated vibration amplitude.

15. A method for detecting contact of a head with a recording medium, comprising:
writing onto the recording medium, a signal that includes at least one predetermined frequency component; and
detecting the contact of the head with the recording medium based on an amplitude of the predetermined frequency component, by reading the signal written on the recording medium while changing a spacing between the head and the recording medium, and generates a detection result.
